(19) United States
(12) Patent Application Publication
(10) Pub. No.: US 2003/0012110 A1
(43) Pub. Date: Jan. 16, 2003

(54) Optical disk, optical disk playback apparatus, and optical disk playback method, optical disk recording apparatus and optical disk recording method, and recording medium

(76) Inventor: Susumu Senshu, Kanagawa (JP)

Correspondence Address: William S. Frommer, Esq., FROMMER LAWRENCE & HAUG LLP, 745 Fifth Avenue, New York, NY, 10151, US

(21) Appl. No.: 09/955,393

(22) Filed: Sep. 18, 2001

(30) Foreign Application Priority Data
Sep. 19, 2000 (JP) 2000-283387

(51) Int. Cl. G11B 7/00

(52) U.S. Cl. 369/59.13; 369/59.26

(57) ABSTRACT

A frame density ratio between a RAM area and a ROM area is set to be a numerical value close to a data density ratio between the RAM area and the ROM area and to be a simple ratio of integers ROM data is subjected to RLL (2, 7) modulation as is a prepit address of RAM data, and dcc of 6 channel bits is inserted after each unit of the ROM data. Frame sync (FS) of 48 channel bits is added at the front of ROM recording frames, while postamble (PO) is added at the end of the ROM recording frames so as to adjust frame length Although data of 156 bytes can be recorded in a single ROM recording frame, data of 155 bytes is recorded in the ROM recording frame as in a RAM data frame. Thus, structure of data higher than that in an ECC format is made to be the same as that of the RAM data.

### BACKGROUND OF THE INVENTION

The present invention relates to an optical disk, an optical disk playback apparatus, an optical disk playback method, and a recording medium, and particularly to an optical disk, an optical disk playback apparatus, an optical disk playback method, and a recording medium that make it possible to record data on the optical disk having a RAM area which is both readable and writable and a ROM area which is only readable by optimum recording and modulating methods for both of the RAM area and the ROM area and to play back such an optical disk without complicating circuit configuration of the playback apparatus.

As techniques for recording and reproducing digital data, there are data recording techniques that use optical disks (including magneto-optical disks) such for example as CD (Compact Disk), MD (Mini-Disk), and DVD (Digital Versatile Disk) as recording media. The optical disk is a general term for recording media that are disks of thin metallic plates protected with plastic which disks are irradiated with laser light to read a signal by change in the reflected light. Optical disks include read only type and DRAW (Direct Read After Write) type optical disks. DRAW type optical disks include write once type and rewritable type optical disks.

Generally, projections and depressions are formed on a recording surface of a read only type or write once type optical disk in such a manner as to correspond to data to be recorded. A depression part is referred to as a pit, whereas a projection part is referred to as a land. When the data recorded on the optical disk is read, projection parts and depression parts are irradiated with laser light, so that the recorded information is read by change in optical density of the reflected light.

A rewritable type optical disk allows a signal recorded once to be erased and overwritten with a new signal. Rewritable type optical disks include phase change type optical disks, for example, on which data is recorded by changing crystal structure of the optical disks with laser light, thereby making it possible to read “0” and “1” using difference in reflectivity that is in accordance with change in the crystal structure (crystal or noncrystal).

The CD is a digital audio disk devised and standardized for recording/reproducing digital data for music, and is in wide and common use. An application of the CD as a recording medium exclusively for reading not only music data but also digital data usable by a computer and the like is CD-ROM (Compact Disk-Read only memory). Write once type CD-R (Compact Disk-Recordable) and rewritable type CD-RW (Compact Disk-ReWritable) were thereafter developed.

MO is a rewritable type magneto-optical disk. In recording data on an MO, magnetism is used as in the case of a floppy disk, a hard disk and the like (although the recording method of an MO is different from that of a floppy disk and the like), and high-density recording is achieved by increasing writing accuracy by optical techniques. Specifically, an optical head applies a narrow laser beam to a position for writing data to thereby bring that portion into a recordable state, and then a magnetic head writes the data. In reading data written once, on the other hand, only the optical head is used.

DVD includes DVD-ROM exclusively for reading, DVD-R allowing writing only once, and rewritable DVD-RAM. The DVD-ROM, the DVD-R, and the DVD-RAM correspond to the CD-ROM, the CD-R, and the CD-RW, respectively, in the category of CD. In order to make recording density of DVD higher than that of CD, a track pitch and pit size of DVD are reduced, and linear speed of track movement (rotational speed of the disk) with respect to an optical pickup (optical head) for reading and writing data is made about 3.3 times higher than that of a single-speed CD. In order to accurately read such dense pits, the DVD is irradiated by an optical pickup with laser light having a wavelength (650 nm or 635 nm) that is shorter than that for CD.

FIG. 1 is a block diagram showing configuration of a conventional optical disk recording and playback apparatus 1.

An I/F (Interface) unit 11 supplies data inputted from an application block (not shown) to an arbitration unit 12, and outputs data supplied from the arbitration unit 12 to the application block. The arbitration unit 12 arbitrates, that is, controls the sending and receiving of data between a buffer memory 13 and the I/F unit 11, an ECC (Error Check and Correct) unit 14, and a modulator-demodulator unit 15.

For faster processing, the buffer memory 13 is used to alternately dispose (that is, interleave) data read from an optical disk 19 or data to be recorded on the optical disk 19 (that is, data received from or sent to the modulator-demodulator unit 15 via the arbitration unit 12) and error correcting code and data of an application (that is, data received from or sent to the ECC unit 14 or the I/F unit 11 via the arbitration unit 12). The ECC unit 14 subjects data inputted from the arbitration unit 12 to error correction processing (decoding) when the data is to be reproduced, and subjects data inputted from the arbitration unit 12 to error correction coding (encoding) when the data is to be recorded.

The modulator-demodulator unit 15 performs predetermined processing such as demodulating data inputted from a signal detecting unit 20 by an RLL (Run Length Limited Code) (1, 7) demodulation method on the basis of a timing signal inputted from a timing generator 22 when the data is to be reproduced, and then outputs the result to the arbitration unit 12. In addition, when data is to be recorded, the modulator-demodulator unit 15 performs predetermined processing such as modulating data inputted from the arbitration unit 12 by an RLL (1, 7) modulation method and inserting sync bits, for example, and then outputs the result to a laser driver 16.

The RLL (a, b) (a and b are both integers) modulation method limits the number of consecutive “0s,” and defines a code such that the number of consecutive “0s” is a or more and b or less.

When data is to be recorded on the optical disk 19, the laser driver 16 drives a laser diode not shown in the figure of an optical head 17 according to the data inputted from the modulator-demodulator unit 15. The laser driver 16 thereby irradiates the optical disk 19 with laser light and thus writes data. When data recorded on the optical disk 19 is to be read, the laser driver 16 drives the laser diode of the optical head 17 to thereby irradiate the optical disk 19 with laser light.

The laser light supplied from the laser diode is applied to a track formed on a recording surface of the optical disk 19, then reflected, and received by a photodetector not shown in the figure within the optical head 17. A flat portion without a pit on the track allows the laser light to be reflected as it is, thus resulting in a high optical density of the reflected light. On the other hand, a portion with a pit diffuses the reflected light, thus resulting in a low optical density of the reflected light. The photodetector detects change in the optical density, converts the change into an electric signal, and then outputs the electric signal to the signal detecting unit 20.

A spindle motor 18 is driven by a driver not shown in the figure to rotate the optical disk 19.

The signal detecting unit 20 detects a signal recorded on the optical disk 19 from the electric signal supplied from the optical head 17, and then supplies the signal to the modulator-demodulator unit 15 and an ID (Identification Data) unit 21. The ID unit 21 performs an RLL (2, 7) demodulation to thereby reproduce ID information corresponding to a prepit address included in the supplied data. The ID information is data for controlling a reproduction position of a data frame.

The timing generator 22 generates a timing signal for data demodulation performed by the modulator-demodulator unit 15 on the basis of the ID information reproduced by the ID unit 21, and then outputs the timing signal to the modulator-demodulator unit 15.

When data inputted from an application is to be recorded on the optical disk 19, the I/F unit 11 supplies the inputted data to the buffer memory 13 via the arbitration unit 12 The data is read from the buffer memory 13 by processing of the arbitration unit 12 and then supplied to the ECC unit 14 for error correction coding. The data is stored in the butter memory 13 again by processing of the arbitration unit 12.

The data that is stored in the buffer memory 13 and has been subjected to error correction coding is read from the buffer memory 13 in predetermined timing by processing of the arbitration unit 12, and then supplied to the modulator-demodulator unit 15. The modulator-demodulator unit 15 performs predetermined processing and then outputs the result to the laser driver 16. The laser driver 16 drives the laser diode not shown in the figure of the optical head 17. The laser driver 16 thereby irradiates the optical disk 19 with laser light and thus writes the data.

When data recorded on the optical disk 19 is reproduced, the data converted into an electric signal by the optical head 17 is read by the signal detecting unit 20, and then-supplied to the modulator-demodulator unit 15. The signal detecting unit 20 supplies the read signal also to the ID unit 21. The ID unit 21 demodulates ID information. The timing generator 22 generates a timing signal for demodulation processing, and then supplies the timing signal to the modulator-demodulator unit 15. The modulator-demodulator unit 15 subjects the data inputted thereto on the basis of the timing signal supplied from the timing generator 22. The demodulated data is supplied via the arbitration unit 12 to the buffer memory 13 to be stored therein.

The data after the demodulation stored in the buffer memory 13 is read from the buffer memory 13 by processing or the arbitration unit 12 and then supplied to the ECC unit 14 for error correction. The data is stored in the buffer memory 13 again by processing of the arbitration unit 12. The error-corrected data is read in predetermined timing by processing of the arbitration unit 12, and then outputted to an application via the I/F unit 11. The data is outputted to a monitor or a speaker not shown in the figure, for example, for reproduction.

In this case, in order to ensure a capability to correct a burst error, the data handled by the ECC unit 14 and the I/F unit 11 and the data handled by the modulator-demodulator unit 15 are stored in the buffer memory 13 such that the direction of the data handled by the ECC unit 14 and the I/F unit 11 is different from that of the data handled by the modulator-demodulator unit 15. Thus, these pieces of data are interleaved.

CD was originally developed as a ROM disk, and thereafter a RAM disk was developed. However, CD does not have a sectorized format, and therefore when data is to be recorded on a RAM disk, linking of the data to be recorded needs to be considered. Thus, storage capacity of the RAM is reduced by an amount of storage required for the linking.

MO is a disk originally developed as a RAM disk. As an area for recording ROM data within an MO, there is a PEP (Phase Encoded Part) area in which information such as sector length, reflectivity, reproducing power, and a type of the medium is recorded. However, the PEP area of the MO allows only a small amount of information to be recorded therein, and an MO with a ROM area having a relatively large storage capacity has not been commercialized yet.

DVD was originally developed as a ROM disk, and thereafter DVD-RAM, which is a RAM disk, was developed. The DVD-ROM disk and the DVD-RAM disk have different disk formats and different controls of access to a sector. Also, as for a rotation method, DVD-ROM employs a CLV (Constant Linear Velocity) method, whereas DVD-RAM employs a Zoned-CLV method.

The CLV (Constant Linear Velocity) method reads and writes data while moving velocity of a recording surface with respect to an optical pickup (for example the optical head 17 in FIG. 1) for data reading or writing is set constant (that is, linear velocity of the recording surface with respect to the optical pickup is set constant) regardless of whether at an inner radius of the recording surface or at an outer radius of the recording surface. The Zoned-CLV method uses a CAV (Constant Angular Velocity) method that reads and writes data while the disk is rotated at a constant rotational velocity (that is, angular velocity of the disk is constant) at all times within a zone. Therefore, the Zoned-CLV method changes the rotational velocity when the zone is changed.

Thus, an optical disk having a RAM area and a ROM area that both allow free access thereto with the ROM area having a relatively large data storage capacity has not been realized.

However, recording information on an optical disk may require a RAM area where rewriting of data is possible and a ROM area for storing a bundle of disk control information and system key information (cryptographic key of contents and the like), for example.

When revocation (processing for authenticating and revoking reproduction of contents) is performed for each type of reproducing apparatus by using the system key information, for example, the type of reproducing apparatus needs to be considered as a rejection unit. Therefore, a very large amount of key information needs to be recorded on the optical disk. Reliability of data recording equal to or higher than that of a RAM area is required of a ROM area. In addition, when defects are taken into consideration, multiple writing of key information may be required. In such a case, the ROM area needs to have a relatively large data storage capacity. It is desired that in an optical disk having a RAM area storage capacity of a few gigabytes to a few tens of gigabytes or more, for example, a ROM area storage capacity of a few megabytes to a few tens of megabytes is secured.

RAM data recorded in the RAM area and ROM data recorded in the ROM area have different physical properties, and therefore optimum recording and modulating methods for the RAM data are different from those for the ROM data. However, when the recording method or the modulating method for the RAM data is different from the recording method or the modulating method for the ROM data, a plurality of data processing circuits need to be provided in a data reproducing apparatus. This results in a complex circuit configuration and a large scale of the apparatus.

### SUMMARY OF THE INVENTION

It is an object of the present invention to make it possible to record data on an optical disk having a RAM area in which both reading and writing of data are possible and a ROM area in which only reading of data is possible by optimum recording and modulating methods for both of the RAM area and the ROM area and to play back such an optical disk without complicating circuit configuration of a playback apparatus.

To achieve the above object, according to a first aspect of the present invention, there is provided an optical disk including: a first area which is both readable and writable; and a second area which is only readable; wherein first data to be recorded in the first area is recorded by a first recording method and a first modulating method; second data to be recorded in the first area is recorded by a second recording method and a second modulating method; and third data to be recorded in the second area is recorded by the second recording method and the second modulating method.

With this configuration, the first data to be recorded in the first area can have a predetermined frame structure and a predetermined block structure for error correction, and the third data to be recorded in the second area can have a frame structure and a block structure for error correction that are identical with the frame structure and the block structure for error correction of the first data.

A ratio between frame length of the first data to be recorded in the first area and frame length of the third data to be recorded in the second area can be a simple ratio of integers.

When b frames of the third data are recordable in a length of a frames of the first data, the frame length of the third data can be set such that a value of b/a is as close as possible to a recording density ratio c/d between data recording density c of the first area and data recording density d of the second area.

When b frames of the third data are recordable in a length of a frames of the first data, the frame length of the third data can be set such that a is as small an integer as possible.

The first area can include a third area for recording fourth data necessary for recording and reproducing the first data by a cluster unit, and the second data can be recorded in the second area, while the third data can be recorded over an entire area where the second data is not recorded.

The first area can include a third area for recording fourth data necessary for recording and reproducing the first data over a plurality of segments, and the second data can be recorded in the second area, while the third data can be recorded over an entire area where the second data is not recorded.

The first modulating method can be an RLL (1, 7) modulation, and the second modulating method can be an RLL (2, 7) modulation.

The first recording method can be a recording method using phase change, and the second recording method can be a recording method using a pit.

The first recording method can be a recording method using magneto-optical recording, and the second recording method can be a recording method using a pit.

According to a second aspect of the present invention, there is provided an optical disk playback apparatus including: a first demodulating means for demodulating first data recorded in a first area and second data recorded in a second area by a first demodulating method; and a second demodulating means for demodulating third data recorded in the first area by a second demodulating method on the basis of the first data demodulated by the first demodulating means.

With this configuration, the optical disk playback apparatus can further include an error correction means for correcting an error of the third data demodulated by the second demodulating means and an error of the second data demodulated by the first demodulating means.

The first demodulating method can be an RLL (2, 7) demodulation, and the second demodulating method can be an RLL (1, 7) demodulation.

According to a third aspect of the present invention, there is provided an optical disk playback method including: a first demodulating step for demodulating first data recorded in a first area and second data recorded in a second area by a first demodulating method; and a second demodulating step for demodulating third data recorded in the first area by a second demodulating method on the basis of the first data demodulated by processing of the first demodulating step.

According to a fourth aspect of the present invention, there is provided a program recorded on a recording medium, the program including: a first demodulating step for demodulating first data recorded in a first area and second data recorded in a second area by a first demodulating method; and a second demodulating step for demodulating third data recorded in the first area by a second demodulating method on the basis of the first data demodulated by processing of the first demodulating step.

According to a fifth aspect of the present invention, there is provided an optical disk recording apparatus for recording date on an optical disk in which second data is prerecorded by a first recording method and a first modulating method in the first area, and third data is prerecorded by the first recording method and the first modulating method in a second area, wherein the recording apparatus has modulating means for modulating the first data by a second modulating method different from the first modulating method, and recording means for recording the first data on the optical disk by a second recording method different from the first recording method.

With this configuration, the third data with a predetermined frame structure and a predetermined block structure for error correction can be prerecorded in the second area, and the recording means can record on the optical disk the first data with a frame structure and a block structure for error correction that are identical with the frame structure and the block structure for error correction of the third data.

The first modulating method can be an RLL (2, 7) modulation, and the second modulating method can be an RLL (1, 7) modulation.

The first recording method can be a recording method using a pit, and the second recording method can be a recording method using phase change.

The first recording method can be a recording method using a pit, and the second recording method can be a recording method using magneto-optical recording.

According to a sixth aspect of the present invention, there is provided an optical disk recording method for recording data on an optical disk in which second data is prerecorded by a first recording method and a first modulating method in the first area, and third data is prerecorded by the first recording method and the first modulating method in a second area, wherein the processing of the modulating step modulates the first data by a second modulating method different from the first modulating method, and the processing of the recording step records the first data on the optical disk by a second recording method different from the first recording method.

According to a seventh aspect of the present invention, there is provided a program recorded on a recording medium in which second data is prerecorded by a first recording method and a first modulating method in the first area, and third data is prerecorded by the first recording method and the first modulating method in a second area, wherein the processing of the modulating step modulates the first data by a second modulating method different from the first modulating method, and the processing of the recording step records the first data on the optical disk by a second recording method different from the first recording method.

With this configuration, the optical disk according to the present invention includes a first area which is both readable and writable, and a second area which is only readable, wherein first data to be recorded in the first area is recorded by a first recording method and a first modulating method, second data to be recorded in the first are is recorded by a second recording method and a second modulating method, and third data to he recorded in the second area is recorded by the second recording method and the second modulating method.

The optical disk playback apparatus, the optical disk playback method, and the program recorded on the recording medium according to the present invention can demodulate first data recorded in a first area and second data recorded in a second area by a first demodulating method, and demodulate third data recorded in the second area by a second demodulating method on the basis of the demodulated second data.

The optical disk recording apparatus, the optical disk recording method, and the program recorded cn the recording medium according to the present invention can receive first data to be recorded in a first area of an optical disk, modulate the inputted first data, and record the modulated first data in the first area of the optical disk, wherein second data is prerecorded by a first recording method and a first modulating method in the first area; third data is prerecorded by the first recording method and the first modulating method in a second area; the first data is modulated by a second modulating method different from the first modulating method; and the first data is recorded on the optical disk by a second recording method different from the first recording method.

According to an eighth aspect of the present invention, there is provided an optical disk including: a first area which is both readable and writable; and a second area which is only readable; wherein data to be recorded in the first area is recorded on the basis of a signal modulated by e first modulating method; and data to be recorded in the second area is recorded on the basis of a signal modulated by a second modulating method different from the first modulating method.

According to a ninth aspect of the present invention, there is provided an optical disk playback apparatus for reproducing data recorded on an optical disk including a first area which is both readable and writable and a second area which is only readable, the optical disk playback apparatus including: a first demodulating unit for demodulating data recorded in the first area by a first demodulating method; and a second demodulating unit for demodulating data recorded in the second area by a second demodulating method different from the first demodulating method.

According to a tenth aspect of the present invention, there is provided an optical disk playback method for reproducing data recorded on an optical disk including a first area which is both readable and writable and a second area which is only readable, the optical disk playback method including: a first demodulating step for demodulating data recorded in the first area by a first demodulating method; and a second demodulating step for demodulating data recorded in the second area by a second demodulating method different from the first demodulating method.

According to an eleventh aspect of the present invention, there is provided a program for an optical disk playback apparatus for reproducing data recorded on an optical disk including a first area which is both readable and writable and a second area which is only readable, the program including: a first demodulating step for demodulating data recorded in the first area by a first demodulating method; and a second demodulating step for demodulating data recorded in the second area by a second demodulating method different from the first demodulating method.

According to a twelfth aspect of the present invention, there is provided an optical disk recording apparatus for recording data on an optical disk including a first area which is both readable and writable and a second area which is only readable and has data prerecorded on the basis of a signal modulated by a first modulating method, the optical disk recording apparatus including: a modulating unit for modulating the data by a second modulating method different from the first modulating method; and a recording unit for recording the data in the first area on the basis of a signal modulated by the modulating unit.

According to a thirteenth aspect of the present invention, there is provided an optical disk recording method for recording data on an optical disk including a first area which is both readable and writable and a second area which is only readable and has data prerecorded on the basis of a signal modulated by a first modulating method, the optical disk recording method including: a modulating step for modulating the data by a second modulating method different from the first modulating method; and a recording step for recording the data in the first area on the basis of the modulated signal.

According to a fourteenth aspect of the present invention, there is provided a program for an optical disk recording apparatus for recording data on an optical disk including a first area which is both readable and writable and a second area which is only readable and has data prerecorded on the basis of a signal modulated by a first modulating method, the program including: a modulating step for modulating the data by a second modulating method different from the first modulating method; and a recording step for recording the data in the first area on the basis of the modulated signal.

The optical disk according to the present invention includes a first area which is both readable and writable, and a second area which is only readable, wherein data to be recorded in the first area is recorded by a first modulating method, and data to be recorded in the second area is recorded by a second modulating method.

With this configuration, the optical disk playback apparatus, the optical disk playback method, and the program recorded on a recording medium according to the present invention can demodulate data recorded in a first area by a first demodulating method, and can demodulate data recorded in a second area by a second demodulating method on the basis of the demodulated data.

The optical disk recording apparatus, the optical disk recording method, and the program recorded on a recording medium according to the present invention can modulate data by a second modulating method different from a first modulating method. and can record the data in a first area of an optical disk including the first area which is both readable and writable and a second area which is only readable and has data prerecorded on the basis of a signal modulated by the first modulating method.

### BRIEF DESCRIPTION OF THE DRAWINGS

FIG. 1 is a block diagram showing configuration of a conventional optical disk recording and playback apparatus;

FIG. 2 is a diagram of assistance in explaining an optical disk to which the present invention is applied;

FIG. 3 is a diagram of assistance in explaining a segment structure of the optical disk of FIG. 2;

FIG. 4 is a diagram of assistance in explaining a structure of a prepit header area in FIG. 3;

FIG. 5 is a diagram of assistance in explaining recording of a cluster;

FIG. 6 is a diagram of as3istance in explaining data structure of a land header and a groove header in FIG. 4;

FIG. 7 is a diagram of assistance in explaining the format of a prepit address in a RAM area;

FIG. 8 is a diagram of assistance in explaining the format of RAM data in a RAM area;

FIG. 9 is a diagram off assistance in explaining a RAM recording frame and a ROM recording frame;

FIG. 10 is a diagram of assistance in explaining zone numbers of a ROM area and a RAM area and the corresponding numbers of data frames recorded; and

FIG. 11 is a diagram of assistance in explaining a recording and reproducing apparatus to which the present invention is applied.

### DETAILED DESCRIPTION OF THE INVENTION

Preferred embodiments of the present invention will hereinafter be described with reference to the drawings.

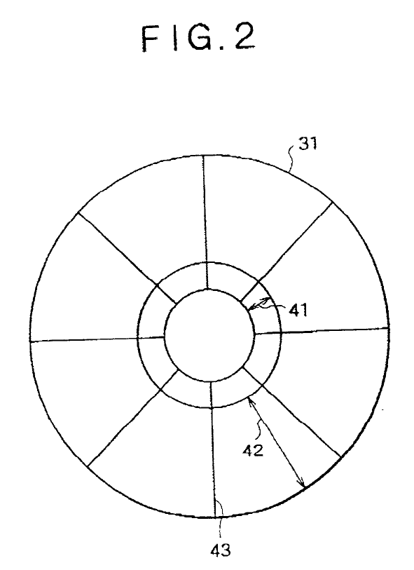

Referring to FIG. 2, a storage area of an optical disk 31 to which the present invention is applied will be described. In this case, the optical disk 31 will be described on an assumption that the optical disk 31 is based on DVR (Digital Video Recording) standards.

The optical disk 31 has a ROM area 41 in a few bands for example three bands) of an inner radius portion of the optical disk 31 in which area pits (prepits) are formed by embossing processing. The optical disk 31 has a RAM area 42 at an outer radius portion thereof in which area data can be written once or is rewritable. RAM data corresponding to contents data such as audio data and video data is recorded in the RAM area 42. The RAM data in the RAM area 42 is recorded by PC (phase change).

A track is formed (pits are present) in a land (a convex portion between grooves of the optical disk 31) and a groove (a groove portion of the optical disk 31) in the RAM area 42. On the other hand, a track is formed in only a portion corresponding to a groove of the RAM area 42 in the ROM area 41. Specifically, while width (length in a direction of the radius of the optical disk 31) of one band of the RAM area 42 and that of the ROM area 41 are the same, when one band in the RAM area 42 has 708 tracks, for example, one band in the ROM area 41 has 354 tracks.

A common prepit header area 43 is disposed in a spoke manner (radial manner) in the ROM area 41 and the RAM area 42 of the optical disk 31. A section between two adjacent prepit header areas 43 is referred to as a segment. In the example of FIG. 2, one circular zone around the disk is divided into eight segments. In other words, a segment may be said to be a data unit in which a prepit header area 43 is present.

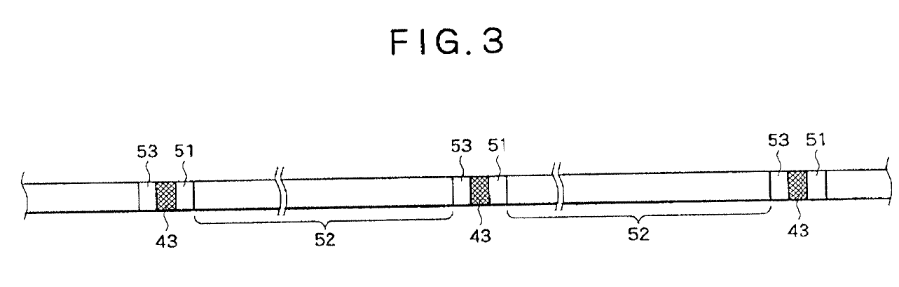

A layout of segments in the RAM area 42 is shown in FIG. 3. A segment comprises a prepit header area 43, a segment run-in area 51, a data frame area 52, and a segment run-out area 53.

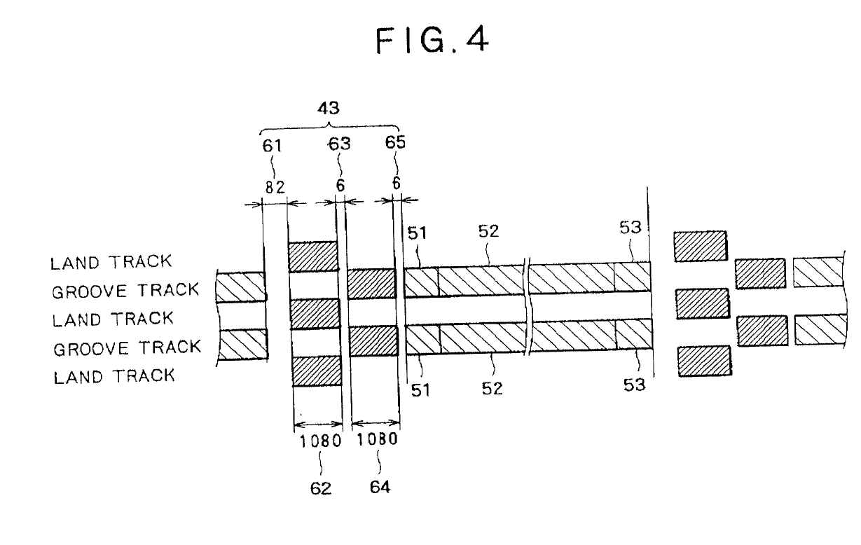

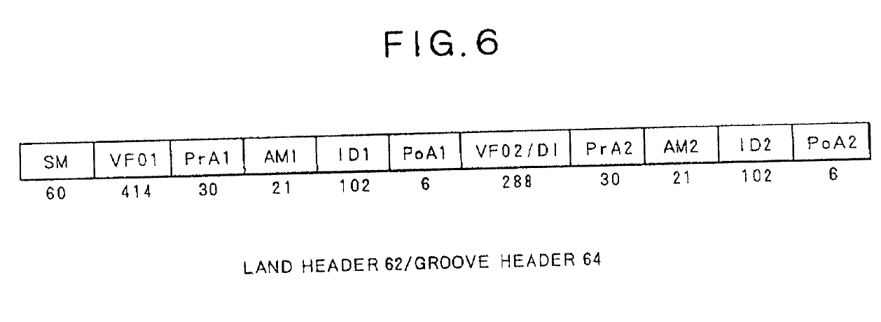

As shown in FIG. 4, a prepit header area 43 includes a mirror mark 61 of 82 channel bits, a land header 62 formed in a land, a GAP area 63 of 6 channel bits provided between the land header 62 and a groove header 64, the groove header 64 formed in a groove, and a GAP area 65 of 6 channel bits provided between the groove header 64 and a segment run-in area 51. The land header 62 and the groove header 64 each have 1080 channel bits and have the same data structure (details will be described later with reference to FIG. 6).

The segment run-in area 51 includes an APC operation area for recording information on APC (automatic power control) operation, which is required when RAM data is recorded or reproduced over a plurality of prepit header areas 43, a VFO (variable Frequency Oscillator) pattern for the pull-in of PLL (Phase Locked Loop), a synch pattern for the pull-in of synch, and the GAP area between the segment run-in area 51 and the prepit header area 43. The segment run-out area 53 includes a pestamble pattern and a GAP area.

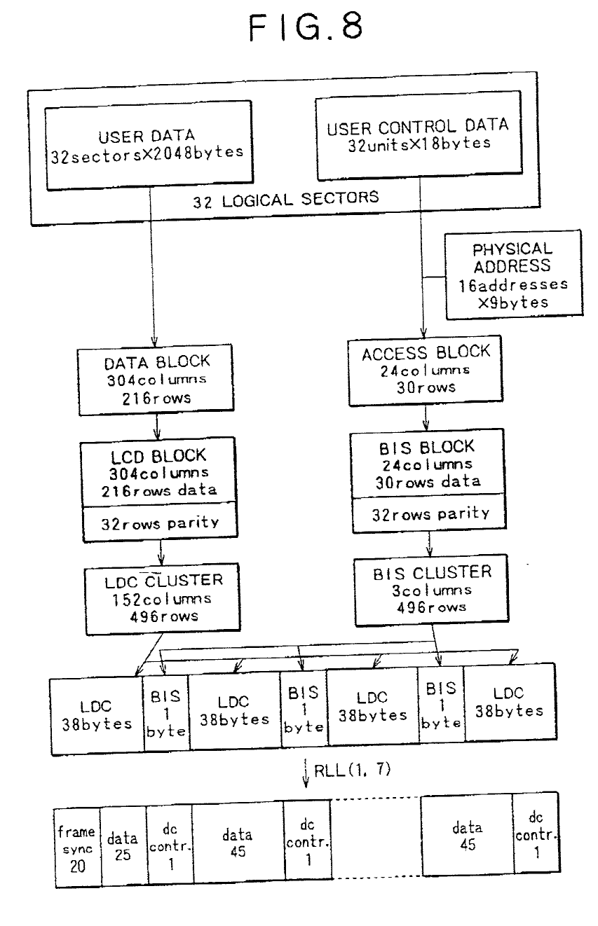

A plurality of RAM data frames are recorded in a data frame area 52 in a format to be described later with reference to FIG. 8. The number of RAM data frames recorded in data frame areas 52 is the same in the same zone, while the number of RAM data frames recorded in data frame areas 52 is increased by one in the next zone on the outer radius side.

In the RAM area 42, data is recorded by a cluster unit. As shown in FIG. 5, a data run-in area 71 is formed at the front of a cluster recorded over a plurality of segments, while a data run-out area 72 is formed at the end of the cluster. The data run-in area 71 includes an APC operation area for recording information on APC operation, a VFO pattern for the pull-in or PLL, a synch pattern for the pull-in of synch, and a GAP area between the data run-in area 71 and an adjacent cluster. The data run-out area 72 includes a postamble pattern and a GAP area.

Data structure of the land header 62 and the groove header 64 of the prepit header area 43 described with reference to FIG. 4 is shown in FIG. 6.

An SM (Sector Mark) is data of 60 channel bits recorded at the front of the land header 62 (or the groove header 64). The next VFO1 is data of 414 channel bits described for control of clock oscillation. The next PrA (Pre-amble) 1 (as well as a PrA2) is data of 30 channel bits. The next AM (Address Mark) 1 (as well as an AM2) is data of 21 channel bits.

ID (identification Data) 1 (as well as ID2) is data (prepit address) of 102 channel bits indicating an address on the optical disk 31. The next PoA (Post-amble) 1 (as well as a PoA2) is data of 6 channel bits. The next VF02/DI (Disc Information) is data of 288 channel bits: the VFO is described in a data zone, and the DI is described in a lead-in zone and a lead-out zone. Thus, in the RAM area 42, the VFO is described (as VFO2) in the entire VF02/DI portion. Then, the PrA2, the AM2, the ID2, and the PoA2 are disposed in that order.

The SM, the VFO, the PrA, the AM, and the PcA are converted into an NRZI (Non Return to Zero Inverted) channel bit stream before being recorded on the optical disk 31. When the data of the VFO2/DI described with reference to FIG. 6 is DI rather than VFO, data of 15 bytes is divided into five pieces of data of 3 bytes, and each of the pieces of data is subjected to RLL (2, 7) modulation. Then, dcc of 6 channel bits is inserted between pieces of data of 48 bits to thereby form DI of 288 channel bits.

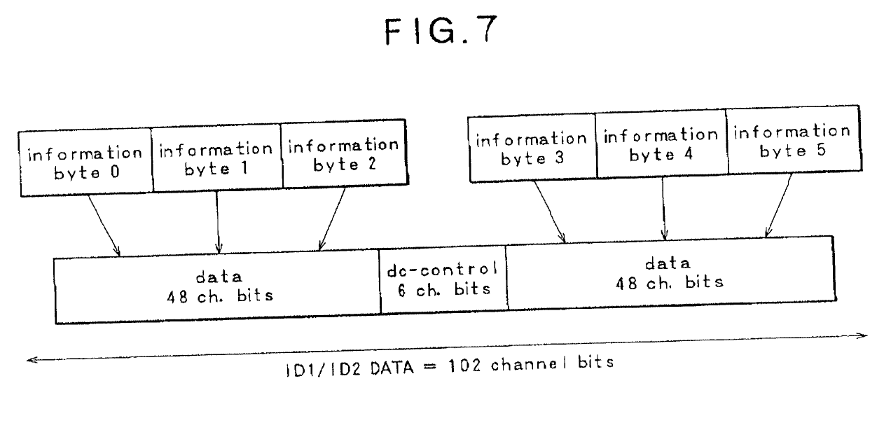

Referring to FIG. 7, the format of the predit address (that is, the IDI and the ID2 in FIG. 6) will be described.

RLL (2, 7) is used as a method of modulating the prepit address The prepit address includes data of 6 bytes (information bytes 0 to 5). Data of 3 bytes, that is, 24 bits of the prepit address is converted into 48 channel bits by the RLL (2, 7) modulation. Then, dc-control (dcc) of 6 channel bits is inserted between two converted pieces of data of 48 channel bits to thereby form ID1 (or ID2) of 102 channel hits. The dcc is inserted to control a dc component of the data, that is, to prevent the dc component from being unbalanced depending on whether the data is 0 or 1.

Referring to FIG. 8, the format of RAM data recorded in a data frame area 52 in FIG. 3 will be described.

User data of 2048 bytes×32 sectors is subjected to Reed-Solomon coding to thereby form a data block of 216 rows×304 columns. Parity of 32 rows is then added to the data block to thereby form an LDC (Long Distance Code) sub-block. The LDC is a correction code having a long inter-code distance. The LDC sub-block is an RS (Reed Solomon Codes) (248, 216, 33)×304 block. Then, an LDC cluster (496 rows×152 columns) is formed from the LDC sub-block.

User control data (control information) of 18 bytes×32 units and a physical address of 9 bytes×16 addresses are subjected to Reed-Solomon coding to thereby form an access block of 30 rows×24 columns. Parity of 32 rows is then added to the access block to thereby form a BIS (burst indicating subcode) sub-block. The BIS is a subcode for indicating the position of a burst error on the optical disk 31. The BIS sub-block is an RS (62, 30, 33)×24 block. Then, a BIS cluster (496 rows×3 columns) is formed from the BIS sub-block The LDC cluster and the BIS cluster, which are units of recording and reproduction, are each formed by 496 data frames A data frame of 155 bytes in which the LDC of 38 bytes and the BIS of 1 byte are alternately arranged is formed, and then divided such that a first group is 25 bits and remaining 27 groups are each 45 bits Then, dcc of 1 bit is inserted after each of the groups, and frame sync of 20 bits is inserted at the front of the groups, whereby a RAM recording frame of 1288 bits (converted into 1932 channel bits by RLL (1, 7) modulation) is formed and then recorded in a data frame area 52 as described with reference to FIG. 3.

Description will next be made of methods of recording and modulating data, frame structure, and ECC (Error Correcting Code) block structure (or arrangement of data forming LDC and BIS) in the ROM area 41.

When compared with the data of the RAM area 42 described with reference to FIGS. 3 to 8, methods of recording and modulating data of the ROM area 41 are the same as those of the prepit address of the RAM area 42, and also the ECC block structure in the ROM area 41 is the same as that of the RAM data. Specifically, in the ROM area 41, data is recorded by pit formation. The data forming LDC and the data forming BIS are formed in substantially the same manner as the data arrangement before the RLL (1, 7) modulation described with reference to FIG. 8, and are modulated by RLL (2, 7) modulation.

A conversion ratio (data bits/channel bits) in the RLL (2, 7) modulation is generally 1/2. A conversion ratio (data bits/channel bits) in the RLL (1, 7) modulation is 2/3. Hence, letting n1 be data density in the RAM area 42 using the RLL (1, 7) modulation and m1 be data density in the ROM area 41 using the RLL (2, 7) modulation, n1/m1=(3/2)/(2/1)=3/4. However, in actuality, the kinds of the dcc and the sync pattern and other factors make it substantially impossible for frame density ratio (ratio in terms of the number of channel bits in a single frame, that is, a reciprocal of frame length) to exactly coincide with the value (3/4). Also, in actuality, it is substantially impossible for the density ratio after addition of the dec and the sync pattern to become a simple ratio of integers.

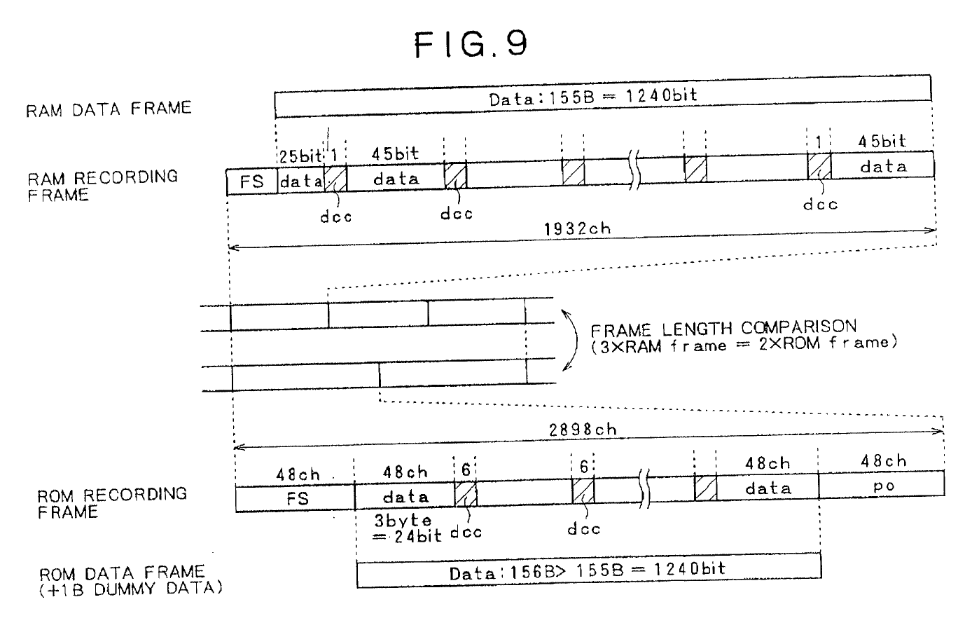

A RAM recording frame and a ROM recording frame will be described with reference to FIG. 9.

As described with reference to FIG. 2, prepit header areas 43 are disposed in a radial manner on the optical disk 31, and thereby the optical disk 31 is divided into segments. As described with reference to FIG. 3, the number of RAM data frames recorded in data frame areas 52 of the RAM area 42 is increased by one when a zone in which the data frame areas 52 are located is changed to the next zone on the outer radius side of the optical disk 31. It is desirable to make segment structure and zone arrangement in the ROM area 41 the same as in the RAM area 42 for a commonality of processing.

When the frame density ratio between the RAM area 42 and the ROM area 41 is not a simple ratio of integers, control of timing for reproduction of data recorded in the ROM area 41 becomes different from that for reproduction of data recorded in the RAM area 42. It is therefore necessary to provide a plurality of signal processing circuits, for example, and perform complex processing in the reproducing apparatus. Thus, in order to make methods of reproducing data recorded in the RAM area 42 and the ROM area 41 the same as that of RAM data recorded in the RAM area 42, a little dummy data is added or channel bits are adjusted in a ROM data frame. As a result of this adjustment, the frame density ratio between the RAM area 42 and the ROM area 41 becomes a simple ratio of integers.

Specifically, when adjustment is made so that length of m2 frames of RAM data is the same as that of n2 frames of ROM data, that is, when the frame density ratio between the RAM area 42 and the ROM area 41 is n2/m2, n2/m2 is adjusted to be a numerical value close to the data density ratio n1/m1 between the RAM area 42 and the ROM area 41 (in the present embodiment, n1/m1−3/4).

In an example of FIG. 9, length of a RAM data frame of the RAM area 42 is 1932 channel bits, whereas length of a ROM data frame of the ROM area 41 is 2898 channel bits. Hence, length of three frames of RAM data is the same as that of two frames of ROM data.

As described above the ROM data is modulated by the RLL (2, 7) modulation as is a prepit address of the RAM data, whereby data of 3 bytes (24 bits) is converted into 48 channel bits. then, dcc of 6 channel bits is inserted after each unit of 48 channel bits. Frame sync (FS) of 48 channel bits is added at the front of ROM recording frames, while postamble (PO) is added at the end of the ROM recording frames so as to adjust frame length (in this case, postamble of 48 channel bits is added). The frame sync and the postamble are dc-free.

Data of 156 bytes can be recorded in a single ROM recording frame. Data of 155 bytes and dummy data of 1 byte are disposed in the ROM recording frame instead of disposing data of 155 bytes and 1 byte from the next data of 155 bytes, whereby essentially data of 155 bytes to match data in a RAM data frame is recorded in the ROM recording frame. Thus, by matching structure of a ROM data frame with that of a RAM data frame, structure of data higher than that in an ECC format (that is, on the application side) can be made to be the same as that of the RAM data. Accordingly, processing of the ROM date and processing of the RAM data can be made to be the same.

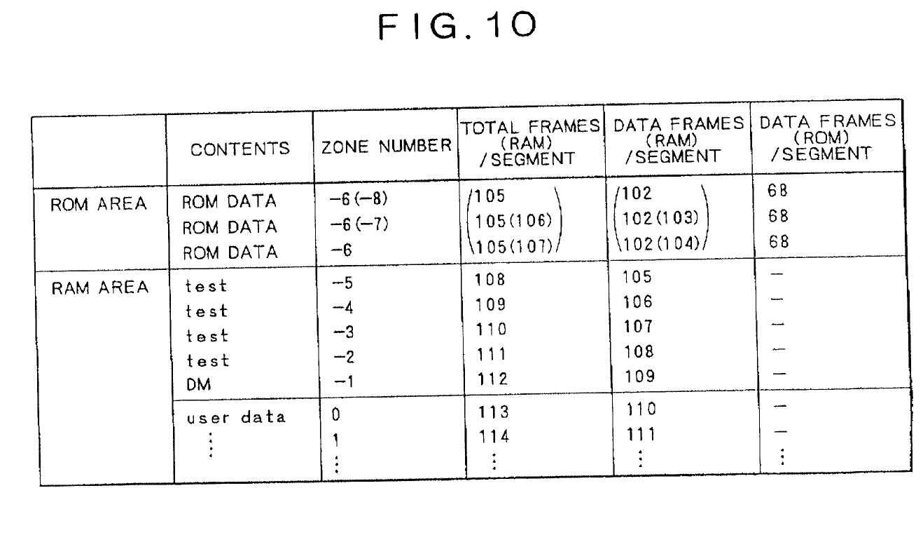

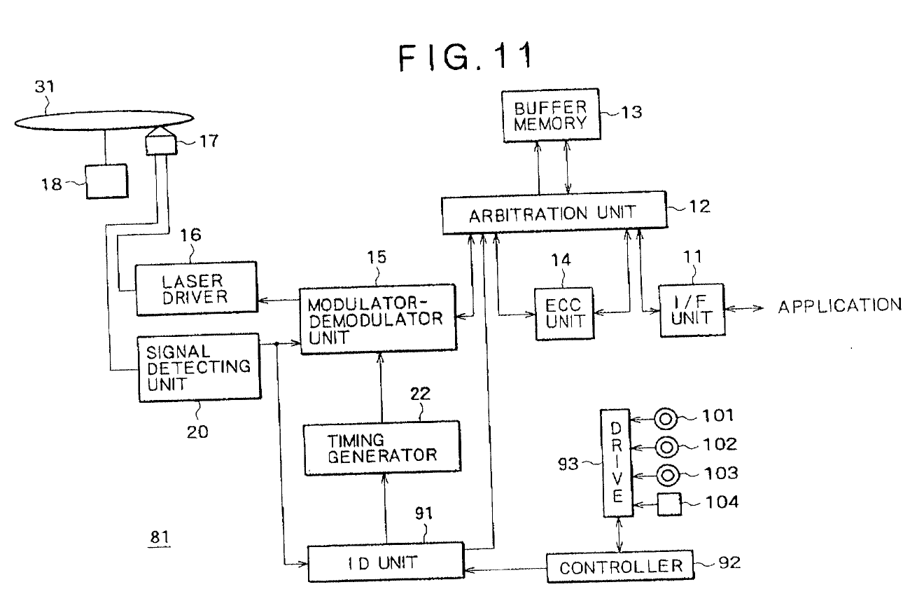

Zone numbers of the optical disk 31 and the number of data frames recorded in each segment will be described with reterenee to FIG. 10.

A total of 113 data frames can be recorded in a prepit header area 43, a segment run-in area 51, a data frame area 52, and a segment run-out area 53 as described with reference to FIG. 3 in a zone 0 (the innermost zone for recording RAM data except a test area) of the RAM area 42, for example. Of the 113 data frames, 110 RAM data frames are recorded in the data frame area 52. Three zones from the innermost radius side of the optical disk 31 serve as the ROM area 41. Therefore, when original RAM data is to be recorded in the ROM area 41, it is possible to record 102 data frames in a zone −8, 103 data frames in a zone −7, and 104 data frames in a zone −6.

As described with reference to FIG. 9, however, two ROM data frames can be recorded in the same length for three RAM data frames. Therefore, zones in which the number of RAM data frames recordable in a data frame area 52 is not equal to a multiple of 3 need to have a segment structure matching that of a zone in which the number of RAM data frames recordable in a data frame area 52 is equal to a multiple of 3. Thus, the three zones in the ROM area 41 are set as a zone −6, and thereby 68 ROM data frames are recorded in each of the zones (more specifically, a data area for one RAM data frame is left over in the zone −7, while a data area for two RAM data frames is left over in the zone −6). Then, assuming that the zone −6 is one zone, the data is read and written by a CAV method.

Consideration will now be given to cases in which the value of m2 described with reference to FIG. 9 is a value other than 3.

For example, when m2=5, the segment structure of the ROM area 41 needs to match that of a zone in which the number of RAM data frames recordable in a data frame area 52 is equal to a multiple of 5. Thus, when RAM data is to be recorded in the ROM area 41, the ROM area 41 needs to have a segment structure such that the number of data frames recordable in a single segment is 100. Accordingly, a data area for two RAM data frames is left over in the zone −8, a data area for three RAM data frames is left over in the zone −7, and a data area for four RAM data frames is left over in the zone −6. Similarly, when m2=8, for example, the ROM area 41 needs to have a segment structure such that the number of data frames recordable in a single segment is 96. Accordingly, a data area for six RAM data frames is left over in the zone −8, a data area for seven RAM data frames is left over in the zone −7 and a data area for eight RAM data frames is left over in the zone −6.

Thus, when forming ROM data frames, it is desirable to set the value of m2 to as small an integer as possible to improve recording density.

As described with reference to FIG. 3, a segment in the RAM area 42 comprises a segment run-in area 51 and a segment run-out area 53 for linking between segments as well as a prepit header area 43 and a data frame area 52. However, unlike the RAM area 42, data is not newly recorded in the ROM area 41.

Accordingly, an APC operation area required when data is recorded or reproduced over a plurality of prepit header areas 43 and a GAP area between the segment run-in area 51 and a prepit address are not required in the ROM area 41. Also, because of a continuous string of pits, a VFO pattern for the pull-in of PLL is not required. In addition, when synchronization timing in the ROM area 41 is known, a synch pattern for the pull-in of synch is not required. Thus, the segment run-in area 51 may be omitted in the ROM area 41. Because of the continuous string of pits, a postamble pattern is not required. Thus, the segment run-out area 53 may also be omitted in the ROM area 41.

Furthermore, for the same reason, a data run-in area 71 at the front of a cluster and a data run-out area 72 at the end of a cluster, which are described with reference to FIG. 5 and required in the RAM area 42, may also be omitted.

By omitting the segment run-in area 51, the segment run-out area 53, the data run-in area 71, and the data run-out area 72, it is possible to improve efficiency of recording ROM data in the ROM area 41.

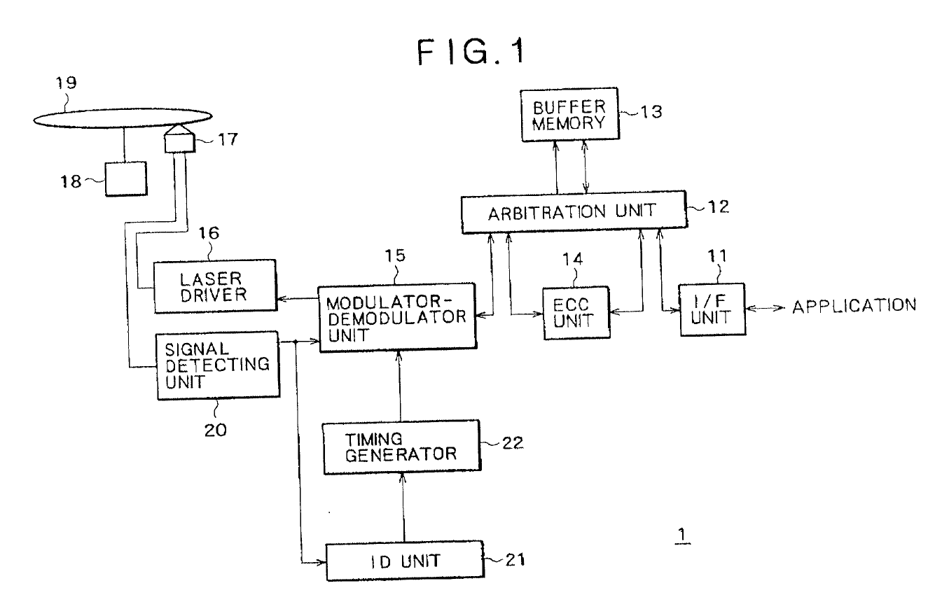

FIG. 11 is a block diagram showing a configuration of a recording and reproducing apparatus 81 to which the present invention is applied. Parts corresponding to those of FIG. 1 are identified by the same reference numerals.

More specifically, the recording and reproducing apparatus 81 has the same configuration as that of the recording and reproducing apparatus 1 of FIG. 1 except that the recording and reproducing apparatus 81 is newly provided with an ID unit 91 instead of the ID unit 21 in FIG. 1, a controller 92 for controlling the ID unit 91, and a drive 93 connected to the controller 92.

An I/F (Interface) unit 11 supplies data inputted from an application block (not shown) to an arbitration unit 12, and outputs data supplied from the arbitration unit 12 to the application block. The arbitration unit 12 arbitrates, that is, controls the sending and receiving of data between a buffer memory 13 and the I/F unit 11, an ECC (Error Check and Correct) unit 14, and a modulator-demodulator unit 15.

For faster processing, the buffer memory 13 is used to alternately dispose (that is, interleave) data read from an optical disk 31 or data to be recorded on the optical disk 31 (that is, data received from or sent to the modulator-demodulator unit 15 via the arbitration unit 12) and error correcting code and data of an application (that is, data received from or sent to the ECC unit 14 or the I/F unit 11 via the arbitration unit 12). The ECC unit 14 subjects data inputted from the arbitration unit 12 to error correction processing (decoding) when the data is to be reproduced, and subjects data inputted from the arbitration unit 12 to error correction coding (encoding) when the data is to be recorded.

The modulator-demodulator unit 15 performs predetermined processing such as demodulating data inputted from a signal detecting unit 20 by an RLL (Run Length Limited Code) (1, 7) demodulation method on the basis of a timing signal inputted from a timing generator 22 when data recorded in a RAM area 42 is to be reproduced, and then outputs the result to the arbitration unit 12. In addition, when data is to be recorded in the RAM area 42, the modulator-demodulator unit 15 performs predetermined processing such as modulating data inputted from the arbitration unit 12 by an RLL (1, 7) modulation method and inserting sync bits, for example, and then outputs the result to a laser driver 16.

When data is to be recorded in the RAM area 42, the laser driver 16 drives a laser diode not shown in the figure of an optical head 17 according to the data inputted from the modulator-demodulator unit 15. The laser driver 16 thereby irradiates the optical disk 31 with laser light and thus writes data. When data recorded on the optical disk 31 is to be read, the laser driver 16 drives the laser diode of the optical head 17 to thereby irradiate the optical disk 31 with laser light.

The laser light supplied from the laser diode is applied to a track formed on a recording surface of the optical disk 31, then reflected, and received by a photodetector not shown in the figure within the optical head 17. A flat portion without a pit on the track allows the laser light to be reflected as it is, thus resulting in a high optical density of the reflected light. On the other hand, a portion with a pit diffuses the reflected light, thus resulting in a low optical density of the reflected light. The photodetector detects change in the optical density, converts the change into an electric signal, and then outputs the electric signal to the signal detecting unit 20.

A spindle motor 18 is driven by a driver not shown in the figure to rotate the optical disk 31.

When data recorded in the RAM area 42 is to be reproduced, the signal detecting unit 20 detects a signal recorded on the optical disk 31 from the electric signal supplied from the optical head 17, and then supplies the signal to the modulator-demodulator unit 15 and the ID unit 91. When data recorded in the ROM area 41 is to be reproduced, the signal detecting unit 20 supplies a detected signal to the ID unit 91.

When the data supplied to the ID unit 91 is RAM data, the ID unit 91 performs an RLL (2, 7) demodulation to thereby reproduce a prepit address (ID information) included in the supplied data, and then outputs the prepit address to the timing generator 22. When the data supplied to the ID unit 91 is ROM data, the ID unit 91 performs an RLL (2, 7) demodulation, and then outputs demodulated data to the arbitration unit 12.

When ROM data recorded in the ROM area 41 of the optical disk 31 is reproduced, the controller 92 generates a control signal to output ROM data demodulated in the same manner as the ID data in the RAM area 42 by the ID unit 91 by the RLL (2, 7) demodulation to the arbitration unit 12 rather than the timing generator 22, and then outputs the control signal to the ID unit 91. The ID unit 91 outputs the demodulated ROM data to the arbitration unit 12 according to the control signal inputted from the controller 92.

The controller 52 is also connected with the drive 93. A magnetic disk 101, an optical disk 102, a magneto-optical disk 103, and a semiconductor memory 104 are inserted into the drive 93 as required so that data is sent to and received from the magnetic disk 101, the optical disk 102, the magneto-optical disk 103, and the semiconductor memory 104.

The timing generator 22 generates a timing signal for RAM data demodulation performed by the modulator-demodulator unit 15 on the basis of the ID information reproduced by the ID unit 91, and then outputs the timing signal to the modulator-demodulator unit 15.

When data inputted from an application is to be recorded in the RAM area 42 of the optical disk 31, the I/F unit 11 supplies the inputted data to the buffer memory 13 viA the arbitration unit 12. The data is reed from the buffer memory 13 by processing of the arbitration unit 12 and then supplied to the ECC unit 14 for error correction coding. The data is stored in the buffer memory 13 again by processing of the arbitration unit 12.

The data that is stored in the buffer memory 13 and has been subjected to error correction coding is read from the buffer memory 13 in predetermined timing by processing of the arbitration unit 12, and then supplied to the modulator-demodulator unit 15. The modulator-demodulator unit 15 performs predetermined processing such as subjecting the data to an RLL (1, 7) modulation, and then outputs the result to the laser driver 16. The laser driver 16 drives the laser diode not shown in the figure of the optical head 17. The laser driver 16 thereby irradiates the optical disk 31 with laser light and thus writes the data.

When RAM data recorded in the RAM area 42 of the optical disk 31 is reproduced, data converted into an electric signal by the optical head 17 is read by the signal detecting unit 20, and then supplied to the modulator-demodulator unit 15, The signal detecting unit 20 supplies the read signal also to the ID unit 91. The ID unit 91 demodulates ID information by the RLL (2, 7) demodulation, thereby reproducing data position information. The ID unit 91 outputs the data position information to the timing generator 22. In response to an input of the data position information, the timing generator 22 generates a timing signal for demodulation processing, and then supplies the timing signal to the modulator-demodulator unit 15. The modulator-demodulator unit 15 subjects the RAM data inputted thereto to the RLL (1, 7) demodulation on the basis of the timing signal supplied from the timing generator 22. The demodulated RAM data is supplied via the arbitration unit 12 to the buffer memory 13 to be stored therein.

The RAM data after the demodulation stored in the buffer memory 13 is read from the buffer memory 13 by processing of the arbitration unit 12 and then supplied to the ECC unit 14 for error correction. The RAM data is stored in the buffer memory 13 again by processing of the arbitration unit 12. The error-corrected data is read in predetermined timing by processing of the arbitration unit 12, and then outputted to an application via the I/F unit 11. The data is outputted to a monitor or a speaker not shown in the figure, for example, for reproduction.

When ROM data recorded in the ROM area 41 of the optical disk 31 is reproduced, data converted into an electric signal by the optical head 17 is read by the signal detecting unit 20, and then supplied to the ID unit 91. The ROM data demodulated by the ID unit 91 by the RLL (2, 7) demodulation is outputted to the arbitration unit 12, and then stored in the buffer memory 13 by processing of the arbitration unit 12.

The data stored in the buffer memory 13 is outputted to the ECC unit 14 by processing of the arbitration unit 12 to be error-corrected by the ECC unit 14. The error-corrected ROM data is stored in the buffer memory 13 again, then read again by processing of the arbitration unit 12, and supplied to an application via the I/F unit 11. On the basis of the supplied ROM data, the application performs processing for revocation of the contents recorded on the optical disk 31, for example.

In this case, in order to ensure a capability to correct a burst error, the data handled by the ECC unit 14 and the I/F unit 11 and the data handled by the modulator-demodulator unit 15 are stored in the buffer memory 13 such that the direction of the data handled by the ECC unit 14 and the I/F unit 11 is different from that of the data handled by the modulator-demodulator unit 15. Thus, these pieces of data are interleaved.

It is to be noted that the above description has been made by taking the optical disk 31 based on DVR standards; however, the present invention is also applicable to other optical disks such as CDs or DVDs or magneto-optical disks such as MDs, for example. Also, in the above description, the ROM data to be recorded in the ROM area 41 and the prepit address in the RAM area 42 are recorded by pit formation, and the RAM data to be recorded in the RAM area 42 is recorded by phase change. However, when the optical disk 31 is a magneto-optical disk such as an MO, for example, the ROM data to be recorded in the ROM area 41 and the prepit address in the RAM area 42 are recorded by pit formation, and the RAM data to be recorded in the RAM area 42 is recorded by magneto-optical recording.

The series of processing steps described above may also be carried out by software. The software is installed from a recording medium onto a computer where programs forming the software are incorporated in dedicated hardware, or a general-purpose personal computer, for example, which can perform various functions by installing various programs thereon.

Examples of the recording medium include program-recorded package media distributed to users to provide a program separately from computers, such an magnetic disks 101 (including floppy disks), optical disks 102 (including CD-ROM (Compact Disk-Read Only Memory) and DVD (Digital Versatile Disk)), magneto-optical disks 103 (including MD (Mini-Disk)), or semiconductor memories 104, as shown in FIG. 11.

In the present specification, the steps of describing a program recorded on a recording medium include not only processing steps carried out in time series in described order but also processing steps carried out in parallel or individually and not necessarily in time series.

In the optical disk according to the prevent invention, data can be recorded on the optical disk having the RAM area in which both reading and writing of data are possible and the ROM area in which only reading of data is possible by the optimum modulating method (or the recording method and modulating method) for both of the RAM area and the ROM area.

In the optical disk playback apparatus, the optical disk playback method, and the program recorded on the recording medium according to the present invention, it is possible to reproduce data recorded on the optical disk, which has the RAM area in which both reading and writing of data are possible and the ROM area in which only reading of data is possible and on which disk the data is recorded by the optimum modulating method (or the recording method and modulating method) for both of the RAM area and the ROM area, without complicating circuit configuration of the playback apparatus.

In the optical disk recording apparatus, the optical disk recording method, and the program recorded on the recording medium according to the present invention, it is possible to record data in the RAM area of the optical disk having the RAM area in which both reading and writing of data are possible and the ROM area in which only reading of data is possible by the optimum modulating method (or the recording method and modulating method) without complicating circuit configuration of the recording apparatus.

While preferred embodiments of the present invention have been described using specific terms, such description is for illustrative purposes only, and it is to be understood that changes and variations may be made without departing from the spirit or scope of the following claims.

What is claimed is:

1. An optical disk comprising:
a first area which is both readable and writable; and
a second area which is only readable;
wherein first data to be recorded in said first area is recorded by a first recording method and a first modulating method;
second data to be recorded in said first area is recorded by a second recording method and a second modulating method; and
third data to be recorded in said second area is recorded by said second recording method and said second modulating method.

2. An optical disk as claimed in claim 1, wherein said first data to be recorded in said first area has a predetermined frame structure and a predetermined block structure for error correction; and
said third data to be recorded in said second area has a frame structure and a block structure for error correction that are identical with said frame structure and said block st ructure for error correction of said first data.

3. An optical disk as claimed in claim 1, wherein a ratio between frame length of said first data to be recorded in said first area and frame length of said third data to be recorded in said second area is a simple ratio of integers.

4. An optical disk as claimed in claim 3, wherein when b frames of said third data are recordable in a length of a frames of said first data, the frame length of said third data is set such that a value of b/a is as close as possible to a recording density ratio c/d between data recording density c of said first area and date recording density d of said second area.

5. An optical disk as claimed in claim 3, wherein when b frames of said third data are recordable in a length of a frames of said first data, the frame length of said third data is set such that a is as small an integer as possible.

6. An optical disk as claimed in claim 1, wherein said first area includes a third area for recording fourth data necessary for recording and reproducing said first data by a cluster unit; and said second data is recorded in said second area, while said third data is recorded over an entire area where said second data is not recorded.

7. An optical disk as claimed in claim 1, wherein said first area includes a third area for recording fourth data necessary for recording and reproducing said first data over a plurality of segments; and said second data is recorded in said second area, while said third data is recorded over an entire area where said second data is not recorded.

8. An optical disk as claimed in claim 1, wherein said first modulating method is an RLL (1, 7) modulation; and said second modulating method is an RLL (2, 7) modulation.

9. An optical disk as claimed in claim 1, wherein said first recording method is a recording method using phase change; and said second recording method is a recording method using a pit.

10. An optical disk as claimed in claim 1, wherein said first recording method is a recording method using magneto-optical recording; and said second recording method is a recording method using a pit.

11. An optical disk playback apparatus for reproducing data recorded on an optical disk including a first area which is both readable and writable and a second area which is only readable, said optical disk playback apparatus comprising:
first demodulating means for demodulating first data recorded in said first area and second data recorded in said second area by a first demodulating method; and
second demodulating means for demodulating third data recorded in said first area by a second demodulating method on the basis of said first data demodulated by said first demodulating means.

12. An optical disk playback apparatus as claimed in claim 11, further comprising:
an error correction means for correcting an error of said third data demodulated by said second demodulating means and an error of said second data demodulated by said first demodulating means.

13. An optical disk playback apparatus as claimed in claim 11, wherein said first demodulating method is an RLL (2, 7) demodulation, and said second demodulating method is an RLL (1, 7) demodulation.

14. An optical disk playback method for an optical disk playback apparatus for reproducing data recorded on an optical disk including a first area which is both readable and writable and a second area which is only readable, said optical disk playback method comprising:
a first demodulating step for demodulating first data recorded in said first area and second data recorded in said second area by a first demodulating method; and
a second demodulating step for demodulating third data recorded in said first area by a second demodulating method on the basis of said first data demodulated by processing of said first demodulating step.

15. A recording medium for recording a computer readable program for an optical disk playback apparatus for reproducing data recorded on an optical disk including a first area which is both readable and writable and a second area which is only readable, said computer readable program comprising;
a first demodulating step for demodulating first data recorded in said first area and second data recorded in said second area by a first demodulating method; and
a second demodulating step for demodulating third data recorded in said first area by a second demodulating method on the basis of said first data demodulated by processing of said first demodulating step.

16. An optical disk recording apparatus for recording data on an optical disk including a first area which is both readable and writable and a second area which is only readable,
wherein second data is prerecorded by a first recording method and a first modulating method in said first area;
third data is prerecorded by said first recording method and said first modulating method in said second area;
said modulating means modulates said first data by a second modulating method different from said first modulating method; and
said recording means records said first data on said optical disk by a second recording method different from said first recording method.

17. An optical disk recording apparatus as claimed in claim 16, wherein said third date with a predetermined frame structure and a predetermined block structure for error correction is prerecorded in said second area; and said recording means records on said optical disk said first data with a frame structure and a block structure for error correction that are identical with said frame structure and said block structure for error correction of said third data.

18. An optical disk recording apparatus as claimed in claim 16, wherein said first modulating method is an RLL (2, 7) modulation; and said second modulating method is an RLL (1, 7) modulation.

19. An opti cal disk recording apparatus as claimed in claim 16, wherein said first recording method is a recording method using a pit; and said second recording method is a recording method using phase change.

20. An optical disk recording apparatus as claimed in claim 16, wherein said first recording method is a recording method using a pit; and said second recording method is a recording method using magneto-optical recording.

21. An optical disk recording method for an optical disk recording apparatus for recording data on an optical disk including a first area which is both readable and writable and a second area which is only readable,
wherein second data is prerecorded by a first recording method and a first modulating method in said first area;
third data is prerecorded by said first recording method and said first modulating method in said second area;
the processing of said modulating step modulates said first data by a second modulating method different from said first modulating method; and
the processing of said recording step records said first data on said optical disk by a second recording method different from said first recording method.

22. A recording medium for recording a computer readable program for an optical disk recording apparatus for recording data on an optical disk including a first area which is both readable and writable and a second area which is only readable,
wherein second data is prerecorded by a first recording method and a first modulating method in said first area;
third data is prerecorded by said first recording method and said first modulating method in said second area;
the processing of said modulating step modulates said first data by a second modulating method different from said first modulating method; and
the processing of said recording step records said first data on said optical disk by a second recording method different from said first recording method.

23. An optical disk including a first area which is both readable and writable and a second area which is only readable,
wherein data to be recorded in said first area is recorded on the basis of a signal modulated by a first noeulating method; and
data to be recorded in said second area is recorded on the basis of a signal modulated by a second modulating method different from said first modulating method.

24. An optical disk playback apparatus for reproducing data recorded on an optical disk including a first area which is both readable and writable and a second area which is only readable, said optical disk playback apparatus comprising:
a first demodulating means for demodulating data recorded in said first area by a first demodulating method; and
a second demodulating means for demodulating data recorded in said second area by a second demodulating method different from said first demodulating method.

25. An optical disk playback method for an optical disk playback apparatus for reproducing data recorded on an optical disk including a first area which is both readable and writable and a second area which is only readable, said optical disk playback method comprising:
a first demodulating step for demodulating data recorded in said first area by a first demodulating method; and
a second demodulating step for demodulating data recorded in said second area by a second demodulating method different from said first demodulating method.

26. A recording medium for recording a computer readable program for an optical disk playback apparatus for reproducing data recorded on an optical disk including a first area which is both readable and writable and a second area which is only readable, said computer readable program comprising:
a first demodulating step for demodulating data recorded in said first area by a first demodulating method; and
a second demodulating step for demodulating data recorded in said second area by a second demodulating method different from said first demodulating method.

27. An optical disk recording apparatus for recording data on an optical disk including a first area which is both readable and writable and a second area which is only readable and has data prerecorded on the basis of a signal modulated by a first modulating method, said optical disk recording apparatus comprising:
a modulating unit for modulating said data by a second modulating method different from said first modulating method; and
a recording unit for recording said data in said first area on the basis of a signal modulated by said modulating unit.

28. An optical disk recording method for recording data on an optical disk including a first area which is both readable and writable and a second area which is only readable and has data prerecorded on the basis of a signal modulated by a first modulating method, said optical disk recording method comprising;
a modulating step for modulating said data by a second modulating method different from said first modulating method; and
a recording step for recording said data in said first area on the basis of said modulated signal.

29. A recording medium for recording a computer readable program for an optical disk recording apparatus for recording data on an optical disk including a first area which is both readable and writable and a second area which is only readable and has data prerecorded on the basis of a signal modulated by a first modulating method, said computer readable program comprising:
a modulating step for modulating said data by a second modulating method different from said first modulating method; and
a recording step for recording said data in said first area on the basis of said modulated signal.
